(19) United States
(12) Patent Application Publication
(10) Pub. No.: US 2025/0167945 A1
(43) Pub. Date: May 22, 2025

(54) METHOD AND APPARATUS FOR MULTIPLE TRANSMISSION AND RECEPTION POINT COMMUNICATION IN COMMUNICATION SYSTEM

(71) Applicant: ELECTRONICS AND TELECOMMUNICATIONS RESEARCH INSTITUTE, Daejeon (KR)

(72) Inventors: Junhyeong KIM, Daejeon (KR); Kapseok CHANG, Daejeon (KR); Il Gyu KIM, Daejeon (KR); Hee Sang CHUNG, Daejeon (KR)

(21) Appl. No.: 18/949,907

(22) Filed: Nov. 15, 2024

Related U.S. Application Data
(60) Provisional application No. 63/600,574, filed on Nov. 17, 2023.

(30) Foreign Application Priority Data
Oct. 30, 2024 (KR) 10-2024-0151390

(51) Int. Cl. H04L 5/00; H04W 56/00

(52) U.S. Cl. CPC H04L 5/0035; H04W 56/001

(57) ABSTRACT

A method of a first transmission and reception point (TRP) may comprise: forming a TRP group including the first TRP and a second TRP; configuring at least one first subband in a first operating band of the first TRP by performing a role of a master TRP; generating at least one subband group including the at least one first subband; setting a transmission (TX) timing and reception (RX) timing for at least one constituent subband of the at least one subband group; and communicating with a terminal based on the set TX timing and RX timing by using the at least one constituent subband in cooperation with the second TRP.

### CROSS-REFERENCE TO RELATED APPLICATIONS

This application claims priority to U.S. Provisional Application 63/600,574, filed on Nov. 17, 2023 in the U.S. Patent and Trademark Office, and Korean Patent Application No. 10-2024-0151390, filed on Oct. 30, 2024 in the Korean Intellectual Property Office (KIPO), the entire contents of which are hereby incorporated by reference.

### BACKGROUND

### 1. Technical Field

The present disclosure relates to a multi-transmission and reception point(TRP) communication technique in a communication system, and more particularly, to a multi-TRP communication technique in a wireless communication system, which can allow multiple TRPs to perform smooth communication with a terminal by adjusting transmission timings and reception timings of the multiple TRPs.

### 2. Related Art

With the development of information and communication technology, various wireless communication technologies are being developed. Representative wireless communication technologies include long-term evolution (LTE) and new radio (NR) defined as the 3rd generation partnership project (3GPP) standards. The LTE may be one of the 4th generation (4G) wireless communication technologies, and the NR may be one of the 5th generation (5G) wireless communication technologies.

For the processing of rapidly increasing wireless data after commercialization of the 4G communication system (e.g., communication system supporting LTE), the 5G communication system (e.g., communication system supporting NR) using a frequency band (e.g., frequency band above 6 GHz) higher than a frequency band (e.g., frequency band below 6 GHz) of the 4G communication system as well as the frequency band of the 4G communication system is being considered. The 5G communication system can support enhanced Mobile BroadBand (eMBB), Ultra-Reliable and Low-Latency Communication (URLLC), and massive machine type communication (mMTC) scenarios.

Such a communication system may require adoption of breakthrough technologies to support the various use cases of 5G wireless networks that support eMBB, URLLC, and mMTC. In particular, to support the exponentially increasing mobile data traffic and expand communication coverage, a wireless device may access a network through one or more distributed transmission and reception points (TRPs). When the wireless device accesses the network through the one or more distributed TRPs, it may experience performance degradation due to a short cyclic prefix (CP).

### SUMMARY

The present disclosure for resolving the above-described problems is directed to providing a multi-TRP communication method and apparatus in a communication system, which can allow multiple TRPs to perform smooth communication with a terminal by adjusting transmission timings and reception timings of the multiple TRPs.

A method of a first transmission and reception point (TRP), according to a first exemplary embodiment of the present disclosure, may comprise: forming a TRP group including the first TRP and a second TRP; configuring at least one first subband in a first operating band of the first TRP by performing a role of a master TRP; generating at least one subband group including the at least one first subband; setting a transmission (TX) timing and reception (RX) timing for at least one constituent subband of the at least one subband group; and communicating with a terminal based on the set TX timing and RX timing by using the at least one constituent subband in cooperation with the second TRP.

The at least one first subband may be at least one of an operating bandwidth, a carrier, a bandwidth part (BWP), a sidelink resource pool, or a resource block (RB) set of unlicensed band communication.

The configuring of the at least one first subband may comprise: receiving first subband configuration information for the first operating band from the base station by performing the role of the master TRP; and configuring the at least one first subband in the first operating band according to the first subband configuration information.

The method may further comprise: configuring or not configuring guard band(s) on at least one side of the at least one first subband.

The generating of the at least one subband group may comprise: selecting the at least one first subband from among first subbands configured in the first operating band of the first TRP; and generating the at least one subband group using the at least one first subband selected from among the first subbands.

The at least one subband group may further include at least one second subband configured by the first TRP or the second TRP in a second operating band of the second TRP, and the generating of the at least one subband group may comprise: selecting the at least one first subband from among first subbands configured in the first operating band of the first TRP; selecting the at least one second subband from among second subbands configured in the second operating band of the second TRP; and generating the at least one subband group using the at least one first subband and the at least second subband.

The setting of the TX timing and RX may comprise: determining a common TX timing and a common RX timing that serve as references for signal transmission; determining a reference TX timing and a reference RX timing for each of TRPs, each of TRP groups, each of subbands, or each of subband groups, based on the common TX timing and the common RX timing; and determining the TX timing and the RX timing of the at least one constituent subband for each of TRPs, each of TRP groups, each of subbands, or each of subband groups, based on the reference TX timing and the RX reception timing.

The determining of the reference TX timing and the reference RX timing may comprise: configuring a reference TX timing offset set and a reference RX timing offset set based on the common TX timing and the common RX timing, respectively; selecting one reference TX timing offset and one reference RX timing offset from the reference TX timing offset set and the reference RX timing offset set, respectively; and determining the reference TX timing and the reference RX timing for each of TRPs, each of TRP groups, each of subbands, or each of subband groups, by applying the one reference TX timing offset and the one reference RX timing offset to the common TX timing and the common RX timing, respectively.

The determining of the TX timing and the RX timing may comprise: configuring a TX timing offset set and an RX timing offset set based on the reference TX timing and the reference RX timing, respectively; selecting a TX timing offset and an RX timing offset from the TX timing offset set and the RX timing offset set, respectively; and determining the TX timing and the RX timing of the at least one constituent subband for each of TRPs, each of TRP groups, each of subbands, or each of subband groups, by applying the TX timing offset and the RX timing offset to the reference TX timing and the reference RX timing, respectively.

The method may further comprise: adjusting the TX timing of the at least one constituent subband according to movement of the terminal; and communicating with the terminal using the at least one subband based on the adjusted TX timing.

The adjusting of the TX timing of the at least one constituent subband may comprise: calculating a difference between a first delay time between the first TRP and the terminal and a second delay time between the second TRP and the terminal according to the movement of the terminal; and adjusting the TX timing of the at least one constituent subband based on the difference.

The method may further comprise: exchanging data and signaling information for multi-TRP communication with the second TRP.

The method may further comprise: allocating the at least one subband or the at least one subband group to the terminal; and transmitting allocation information of the at least one subband or the at least one subband group to the terminal.

A method of a terminal, according to a second exemplary embodiment of the present disclosure, may comprise: receiving subband configuration information from a first transmission and reception point (TRP); receiving subband activation information from the first TRP; and receiving data from the first TRP through at least one subband based on the received subband configuration information and the received subband activation information.

The subband configuration information may be at least one of configuration information of subbands of the first TRP, configuration information of subbands of the terminal, or configuration information of a subband group including subbands of the first TRP.

In the receiving of the subband configuration information, the terminal may receive the subband configuration information from the first TRP through at least one of a data channel, a control channel, a radio resource control (RRC) signaling, or a medium access control (MAC) control element (CE).

A first transmission and reception point (TRP) according to a third exemplary embodiment of the present disclosure may comprise at least one processor, wherein the at least one processor may cause the first TRP to perform: forming a TRP group including the first TRP and a second TRP; configuring at least one first subband in a first operating band of the first TRP by performing a role of a master TRP; generating at least one subband group including the at least one first subband; setting a transmission (TX) timing and reception (RX) timing for at least one constituent subband of the at least one subband group; and communicating with a terminal based on the set TX timing and RX timing by using the at least one constituent subband in cooperation with the second TRP.

In the generating of the at least one subband group, the at least one processor may further cause the first TRP to perform: selecting the at least one first subband from among first subbands configured in the first operating band of the first TRP; and generating the at least one subband group using the at least one first subband selected from among the first subbands.

The at least one subband group may further include at least one second subband configured by the first TRP or the second TRP in a second operating band of the second TRP, and in the generating of the at least one subband group, the at least one processor may further cause the first TRP to perform: selecting the at least one first subband from among first subbands configured in the first operating band of the first TRP; selecting the at least one second subband from among second subbands configured in the second operating band of the second TRP; and generating the at least one subband group using the at least one first subband and the at least second subband.

The at least one processor may further cause the first TRP to perform: adjusting the TX timing of the at least one constituent subband according to movement of the terminal; and communicating with the terminal using the at least one subband based on the adjusted TX timing.

According to the present disclosure, a TRP may be included in a TRP group. A TRP included in the TRP group, which is a mater node, may set a downlink transmission timing and uplink transmission timing for each TRP within the TRP group. In this case, the TRP may set the downlink transmission timing and uplink transmission timing by considering a distance between each TRP and a terminal.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a first exemplary embodiment of a multi-TRP-based communication system.

FIGS. 4A to 4G are conceptual diagrams illustrating a first exemplary embodiment of a communication system including TRPs and a terminal.

FIGS. 5A and 5B are conceptual diagrams illustrating a first exemplary embodiment of subbands.

FIGS. 6A to 6D are conceptual diagrams illustrating a first exemplary embodiment of subband groups of TRPs.

FIG. 7 is a conceptual diagram illustrating a first exemplary embodiment of subband groups of a TRP and subband groups of terminals.

FIG. 8 is a conceptual diagram illustrating a second exemplary embodiment of subband groups of TRPs.

FIG. 9 is a conceptual diagram illustrating a first exemplary embodiment of a method for grouping TRPs.

FIG. 10 is a conceptual diagram illustrating a first exemplary embodiment of a method for updating TRP groups.

FIG. 11 is a conceptual diagram illustrating a first exemplary embodiment of a method of setting TX timing and RX timing.

FIG. 12 is a conceptual diagram illustrating a first exemplary embodiment of a method of adjusting TX timing and RX timing.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

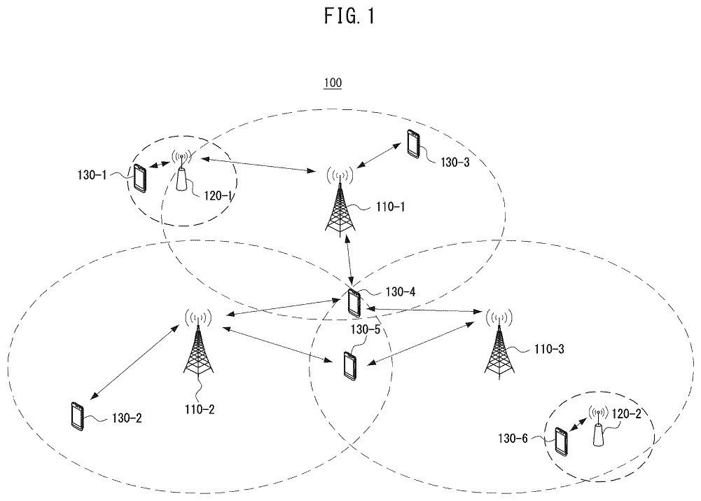

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

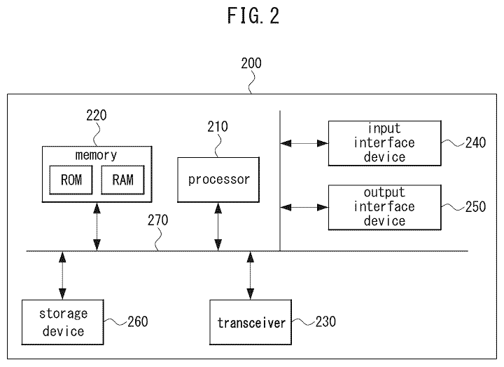

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), eNB, gNB, or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, a communication system may require adoption of breakthrough technologies to support the various use cases of 5G wireless networks that enable large-scale connectivity, high capacity, ultra-reliability, and low latency. In particular, to support the exponentially increasing mobile data traffic and expand communication coverage, a wireless device may access a network through one or more distributed transmission and reception points (TRPs). Such a communication system may be a multi-TRP-based communication system. The multi-TRP-based communication system can effectively improve communication performance in terms of reliability, coverage, and transmission capacity by supporting flexible deployment scenarios.

The 5G New Radio (NR) standards have been designed to support flexible air interfaces that accommodate various use cases such as enhanced Mobile Broadband (eMBB), Ultra-Reliable and Low Latency Communication (URLLC), and massive Machine Type Communication (mMTC). Multi-TRP technology, one of the core technologies of 5G NR, can improve communication reliability by maintaining data transmission through links with other TRPs even if a path with one TRP is blocked, leveraging spatial diversity. Furthermore, multi-TRP transmission enables efficient spatial multiplexing of distributed antennas, leading to performance improvements in terms of system throughput.

The release 15 (Rel-15) of the 5G NR standards have been designed to support multi-TRP functionality in subsequent releases (e.g. Rel-16, Rel-17, etc.). The release 16 of the 3GPP 5G NR standards have introduced non-coherent joint transmission (NCJT) schemes as a multi-TRP transmission mechanism to enhance downlink (DL) transmission speed and spectral efficiency for users at cell edges.

The release 16 has introduced two types of NCJT transmission schemes: a single downlink control information (DCI)-based approach and a multi-DCI-based approach, taking into account various capabilities of the actual backhaul. In addition, the release 16 can support single-DCI-based retransmission to enhance transmission reliability by leveraging a spatial diversity gain of multi-TRP transmission.

Meanwhile, one objective of 5G and 6G communication systems may be to improve transmission rates by using high-frequency bands, such as millimeter wave bands, to enable the use of broader bandwidths. However, due to characteristics of orthogonal frequency-division multiplexing (OFDM), frequency Doppler shift/spread effects may increase with higher frequency bands as mobility of a terminal increases. To account for this increase in Doppler shift/spread effects, a communication system may design wider subcarrier spacing. As a result, a symbol length and a cyclic prefix (CP) length of OFDM signals may be reduced. A root mean square (RMS) delay spread may be relatively small in high-frequency bands due to the nature of high frequencies. When the terminal communicates with a single TRP, a short CP may not pose significant issues. However, when the terminal communicates with multiple TRP, a short CP may become a substantial issue.

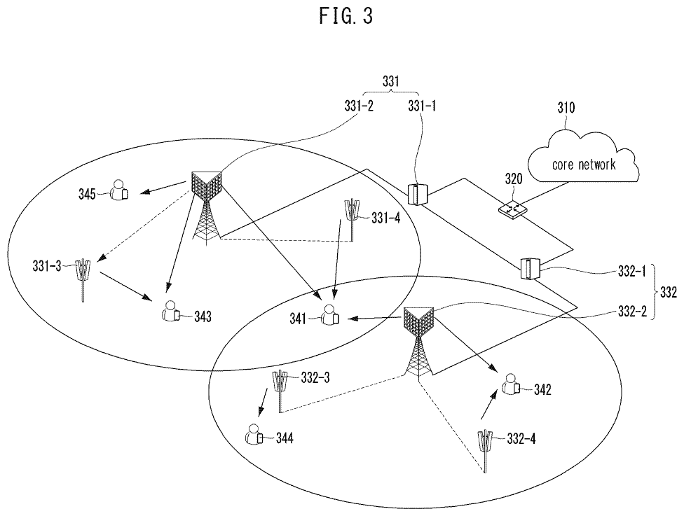

FIG. 3 is a conceptual diagram illustrating a first exemplary embodiment of a multi-TRP-based communication system.

Referring to FIG. 3, a communication system may include a core network 310, a gateway 320, an access network, and the like. Here, the core network 310 supporting 4G communication may include a mobility management entity (MME), a serving-gateway (S-GW), a packet data network (PDN) gateway (P-GW), and the like. The core network 310 supporting 5G communication may include an access and mobility management function (AMF) entity, a user plane function (UPF) entity, a P-GW, and the like. The access network may include base stations 331 and 332, terminals 341 to 345, and the like.

The base station 331 may include a central unit (CU) 331-1, a distributed unit (DU) 331-2, and TRPs 331-3 and 331-4. In addition, the base station 332 may include a CU 332-1, a DU 332-2, and TRPs 332-3 and 332-4. The base stations 331 and 332 may be described as gNBs according to a 5G communication system. The DU 331-2 included in the base station 331 may be connected to the two different TRPs 331-3 and 331-4. In addition, the DU 332-2 included in the base station 332 may be connected to the two different TRPs 332-3 and 332-4.

The CU 331-1 may be connected to the DU 331-2 by wire toward the wireless section, and may be connected to the core network 310 by wire via the gateway 320. In addition, the CU 331-1 may be connected either wirelessly or by wire to the CU 332-1 of the adjacent base station 332. In addition, the CU 332-1 may be connected to the DU 332-2 by wire toward the wireless section, and may be connected to the core network 310 by wire via the gateway 320. In addition, the CU 332-1 may be connected either wirelessly or by wire to the CU 331-1 of the adjacent base station 331.

The DU 331-2 may be wirelessly connected to the multiple TRPs 331-3 and 331-4. In addition, the DU 331-2 may be connected to the terminals 341, 343, and 345. The DU 332-2 may be wirelessly connected to the multiple TRPs 332-3 and 332-4. In addition, the DU 332-2 may be connected to the terminals 342 and 344.

The TRP 331-3 may be connected to the DU 331-2 and may be connected to the terminal 343. The TRP 331-4 may be connected to the DU 331-2 and may be connected to the terminal 341. In addition, the TRP 332-3 may be connected to the DU 332-2 and may be connected to the terminal 344. The TRP 332-4 may be connected to the DU 332-2 and may be connected to the terminal 342.

In this case, the terminal 342 may perform multi-TRP communication with the DU 332-2 and the TRP 332-4 of the base station 332. Here, a distance difference between the DU 332-2 and the TRP 332-4 may depart from a certain range. Then, a time difference between a signal received at the terminal 342 from the DU 332-2 and a signal received at the terminal 342 from the TRP 332-4 may deviate from a CP, which may cause serious performance degradation. In the case of an OFDM system in a high-frequency band, the CP may be very short. Accordingly, such a phenomenon may occur frequently. Therefore, the communication system may require introduction of a technique to solve such a phenomenon.

Accordingly, the present disclosure aims to provide a method and device for controlling transmission timings and reception timings of multiple TRPs in a wireless communication system so that the multiple TRPs can perform smooth communication with a terminal in a high-frequency band.

In the present disclosure, examples of a ‘TRP’ may include a base station, a distributed unit (DU) of a base station, a macro cell, a small cell, a pico cell, a femto cell, a fixed or mobile relay, a Wi-Fi access point (AP), a remote radio head (RRH), a relay node, a repeater, or a distributed antenna, among others. A TRP may also include a terminal. An example of a node communicating with a TRP may be a terminal. Additionally, examples of a node communicating with a TRP may include a base station, a fixed or mobile relay, a Wi-Fi AP, and similar devices. Here, a communication node may refer to an antenna of the communication node. Furthermore, for ease of explanation, a TRP may be referred to as a base station, and its counterpart node may be referred to as a terminal. However, a terminal or its antenna may also serve as a TRP.

Accordingly, the disclosed methods may be applied to various communication modes, including sidelink (SL) communication between terminals as well as general downlink (DL) and uplink (UL) communication between a base station and a terminal. Thus, while the methods of the present disclosure are described using terms like DL and UL for general cellular communication, they are not limited to cellular systems and may equally apply to various wireless communication systems, including Wi-Fi. Meanwhile, the TRP and terminal may include, for example, communication nodes installed in aircraft, ships, satellites, high altitude platform stations (HAPS), and unmanned aerial vehicles or drones.

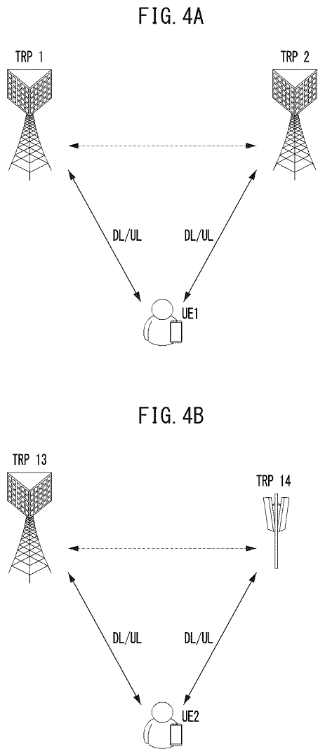

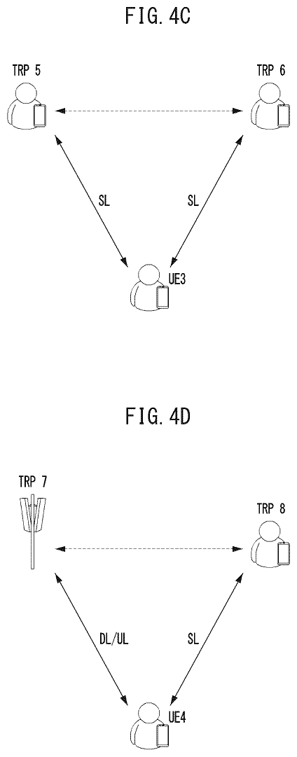

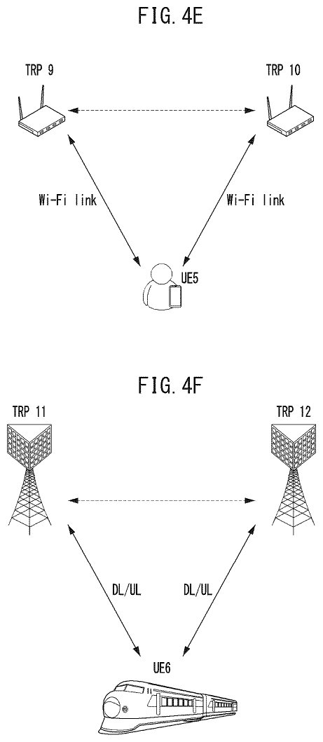

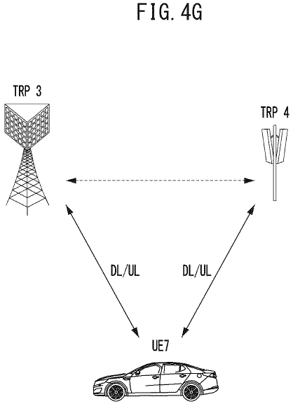

FIGS. 4A to 4G are conceptual diagrams illustrating a first exemplary embodiment of a communication system including TRPs and a terminal.

Referring to FIG. 4A, a first TRP (i.e. TRP 1) may be a base station, and a second TRP (i.e. TRP 2) may also be a base station. In addition, a first terminal (i.e. UE1) may be a cellular device, a Wi-Fi station, or the like. The first TRP and the second TRP may be connected by a wireless backhaul. The first TRP and the first terminal may use downlink and uplink. In addition, the second TRP and the first terminal may also use downlink and uplink.

Referring to FIG. 4B, a third TRP (i.e. TRP 3) may be a base station, and a fourth TRP (i.e. TRP 4) may be a fixed/mobile relay, repeater, distributed antenna, or the like. In addition, a second terminal (i.e. UE2) may be a cellular device, a Wi-Fi station, or the like. The third TRP and the fourth TRP may be connected by a wireless backhaul. The third TRP and the second terminal may use downlink and uplink. In addition, the fourth TRP and the second terminal may also use downlink and uplink.

Referring to FIG. 4C, a fifth TRP (i.e. TRP 5) may be a cellular device, a Wi-Fi station, or the like, and a sixth TRP (i.e. TRP 6) may also be a cellular device, a Wi-Fi station, or the like. In addition, a third terminal (i.e. UE3) may also be a cellular device, a Wi-Fi station, or the like. The fifth TRP and the sixth TRP may be connected by a wireless backhaul. The fifth TRP and the third terminal may use sidelink. In addition, the sixth TRP and the third terminal may also use sidelink.

Referring to FIG. 4D, a seventh TRP (i.e. TRP 7) may be a fixed/mobile relay, repeater, distributed antenna, or the like, and an eighth TRP (i.e. TRP 8) may be a cellular device, a Wi-Fi station, or the like. In addition, a fourth terminal (i.e. UE4) may be a cellular device, a Wi-Fi station, or the like. The seventh TRP and the eighth TRP may be connected by a wireless backhaul. The seventh TRP and the fourth terminal may use downlink/uplink. In addition, the eighth TRP and the fourth terminal may use sidelink.

Referring to FIG. 4E, a ninth TRP (i.e. TRP 9) may be a Wi-Fi AP, and a tenth TRP (i.e. TRP 10) may also be a Wi-Fi AP. In addition, a fifth terminal (i.e. UE5) may be a cellular device, a Wi-Fi station, or the like. The ninth TRP and the tenth TRP may be connected by a wireless backhaul. The ninth TRP and the fifth terminal may be connected by a Wi-Fi link. In addition, the tenth TRP and the fifth terminal may also be connected by a Wi-Fi link.

Referring to FIG. 4F, an eleventh TRP (i.e. TRP 11) may be a base station, and a twelfth TRP (i.e. TRP 12) may also be a base station. In addition, a sixth terminal (i.e. UE6) may be mounted on a vehicle (e.g. high-speed train), etc. The eleventh TRP and the twelfth TRP may be connected by a wireless backhaul. The eleventh TRP and the sixth terminal may use downlink and uplink. In addition, the twelfth TRP and the sixth terminal may also use downlink and uplink.

Referring to FIG. 4G, a thirteenth TRP (i.e. TRP 13) may be a base station, and a fourteenth TRP TRP14 may be a fixed/mobile repeater, repeater, distributed antenna, or the like. In addition, a seventh terminal UE7 may be mounted on a vehicle (e.g. car), etc. The thirteenth TRP and the fourteenth TRP may be connected by a wireless backhaul. The thirteenth TRP and the seventh terminal may use downlink and uplink. In addition, the fourteenth TRP and the seventh terminal may also use downlink and uplink.

I. Case where a TRP Configures One or More Subbands

In the present disclosure, a TRP may configure one or more subbands.

(A) A subband may be configured as in several exemplary embodiments below, without being limited thereto.

(A1) A subband may be the entire operating bandwidth of the TRP

(A2) A subband may be a carrier. In this case, the carrier may be a DL carrier, a UL carrier, or a sidelink (SL) carrier. A type of the carrier may include a primary cell (PCell), a secondary cell (SCell), a primary secondary cell (PSCell), a special cell (SpCell), or the like.

(A3) A subband may be a bandwidth part (BWP). The BWP may be a DL BWP, a UL BWP, a SL BWP, or the like.

(A4) A subband may be a sidelink (SL) resource pool.

(A5) A subband may be a resource block (RB) set of unlicensed band communication.

(B) The subband(s) may be configured identically for the TRPs. Alternatively, the subband(s) may be configured differently for each TRP. Each TRP may allocate one or more subbands configured by itself or another TRP to terminal(s). In this case, multiple terminals communicating with the same TRP may be allocated one or more identical subbands. In the present disclosure, a subband configured for each TRP may be a TRP-specific subband and may be referred to as a TRP subband. A subband configured for each terminal may be a terminal-specific subband (i.e. UE-specific subband) and may be referred to as a UE subband. Unless otherwise specified, a term ‘subband’ may refer to ‘TRP subband’ and/or ‘UE subband’.

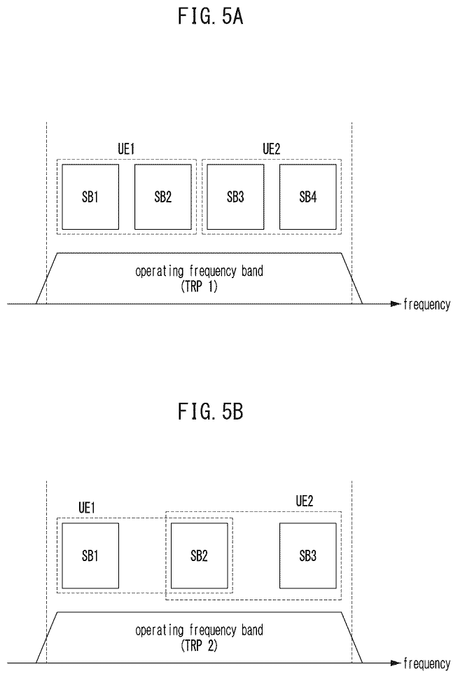

FIGS. 5A and 5B are conceptual diagrams illustrating a first exemplary embodiment of subbands.

Referring to FIG. 5A, a first TRP (i.e. TRP 1) may configure TRP subbands (i.e. SB1 to SB4) by itself or another TRP in an operating frequency band. Then, the first TRP may allocate the TRP subband 1 (i.e. SB1) and TRP subband 2 (i.e. SB2) to a first terminal (i.e. UE1) with which the first TRP communicates. The first TRP may allocate the TRP subband 3 (i.e. SB3) and TRP subband 4 (i.e. SB4) to a second terminal (i.e. UE2) with which the first TRP communicates. Here, the TRP subband 1 and TRP subband 2 may be indexed as a UE subband 1 and UE subband 2 of the first terminal, respectively. In addition, the TRP subband 3 and TRP subband 4 may be indexed as a UE subband 1 and UE subband 2 of the second terminal, respectively.

Referring to FIG. 5B, a second TRP (i.e. TRP 2) may configure TRP subbands (i.e. SB1 to SB3) by itself or another TRP in an operating frequency band. Then, the second TRP may allocate the TRP subband 1 (i.e. SB1) and TRP subband 2 (i.e. SB2) to the first terminal (i.e. UE1) with which the second TRP communicates. The second TRP may allocate the TRP subband 2 (i.e. SB2) and TRP subband 3 (i.e. SB3) to a second terminal (i.e. UE2) with which the second TRP communicates. Here, the second TRP may index the TRP subband 1 and the TRP subband 2 as a UE subband 1 and UE subband 2 of the first terminal, respectively. In addition, the second TRP may index the TRP subband 2 and the TRP subband 3 as a UE subband 1 and UE subband 2 of the second terminal, respectively. In this manner, the first terminal and the second terminal may share the TRP subband 2.

(C) Guard bands (GBs) may be configured on both sides of a subband. Alternatively, a guard band may be configured on either side of a subband. Alternatively, a guard band may not be configured on either side of a subband. A guard band may be configured between two adjacent subbands. Alternatively, a guard band may not be configured between two adjacent subbands. For example, two adjacent subbands may have the same transmission (TX) timing boundary and/or reception (RX) timing boundary. A guard band between two subbands having the same TX timing boundary and/or RX timing boundary may be omitted.

II. Case where a TRP Performs Subband Grouping

A TRP may perform subband grouping. In the present disclosure, subband grouping may include intra-TRP subband grouping, inter-TRP subband grouping, and terminal subband grouping. In addition, unless otherwise specified in the present disclosure, a term ‘subband group’ may refer to ‘intra-TRP subband group’, ‘inter-TRP subband group’, and/or ‘terminal subband group, or the like’.

(A) On or more subbands of a TRP may form an intra-TRP subband group. One or more subbands of a terminal may form a terminal subband group. Each subband may be included in one or more subband groups. In addition, each subband may additionally comprise one or more resource sets. The resource sets may overlap each other. Alternatively, the resource sets may not overlap each other. The resource set may comprise contiguous resources. Alternatively, the resource set may comprise one or more non-contiguous resources. Here, resources of the resource set may include RBs, RB groups, interlaces, or the like.

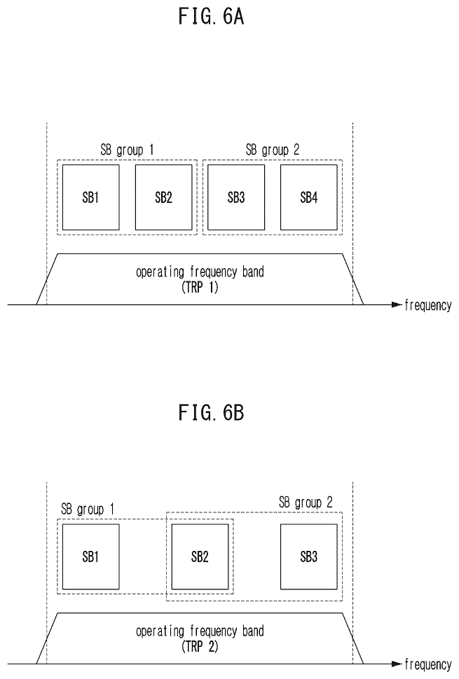

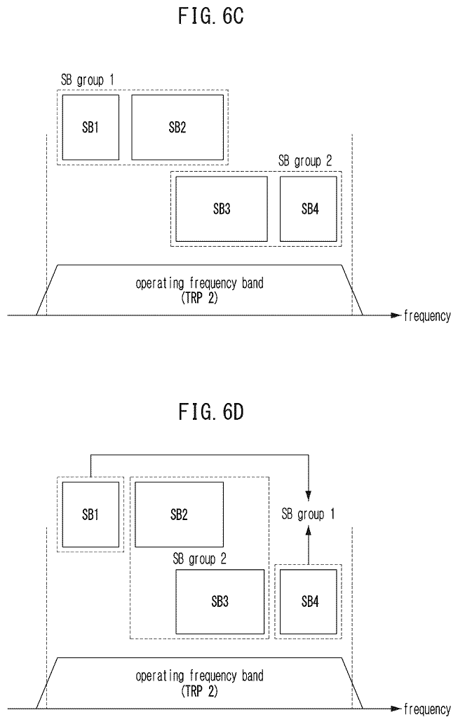

FIGS. 6A to 6D are conceptual diagrams illustrating a first exemplary embodiment of subband groups of TRPs.

Referring to FIG. 6A, a first TRP (i.e. TRP 1) may configure TRP subbands (i.e. SB1 to SB4) by itself or another TRP in an operating frequency band. The first TRP may form a TRP subband group 1 (i.e. SB group 1) using the adjacent TRP subband 1 (i.e. SB1) and TRP subband 2 (i.e. SB2). In addition, the first TRP may form a TRP subband group 2 (i.e. SB group 2) using the adjacent TRP subband 3 (i.e. SB3) and TRP subband 4 (i.e. SB4).

Referring to FIG. 6B, a first TRP (i.e. TRP 1) may configure TRP subbands (i.e. SB1 to SB3) by itself or another TRP in the operating frequency band. The first TRP may form a TRP subband group 1 (i.e. SB group 1) using the adjacent TRP subband 1 (i.e. SB1) and TRP subband 2 (i.e. SB2). In addition, the first TRP may form a TRP subband group 2 (i.e. SB group 2) using the adjacent TRP subband 2 (i.e. SB2) and TRP subband 3 (i.e. SB3). In this manner, the TRP subband 2 may be included in both the TRP subband group 1 and TRP subband group 2.

Referring to FIG. 6C, a first TRP (i.e. TRP 1) may configure TRP subbands (i.e. SB1 to SB4) by itself or another TRP in the operating frequency band. The first TRP may form a TRP subband group 1 (i.e. SB group 1) using the adjacent TRP subband 1 (i.e. SB1) and TRP subband 2 (i.e. SB2). In addition, the first TRP may form a TRP subband group 2 (i.e. SB group 2) using the adjacent TRP subband 3 (i.e. SB3) and TRP subband 4 (i.e. SB4).

Referring to FIG. 6D, a first TRP (i.e. TRP 1) may configure TRP subbands (i.e. SB1 to SB4) by itself or another TRP in the operating frequency band. The first TRP may form a TRP subband group 1 (i.e. SB group 1) using the non-adjacent TRP subband 1 (i.e. SB1) and TRP subband 4 (i.e. SB4). In addition, the first TRP may form a TRP subband group 2 (i.e. SB group 2) using the adjacent TRP subband 2 (i.e. SB2) and TRP subband 3 (i.e. SB3).

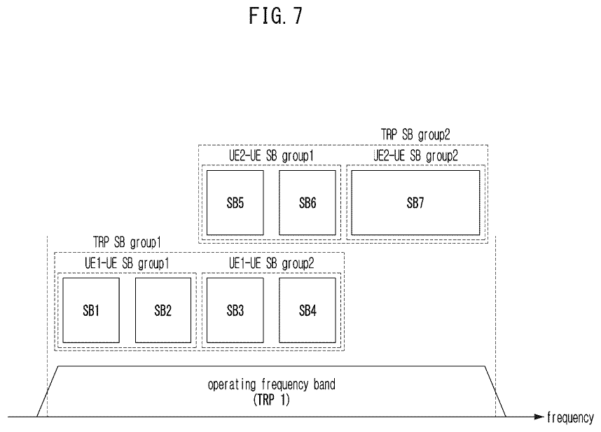

FIG. 7 is a conceptual diagram illustrating a first exemplary embodiment of subband groups of a TRP and subband groups of terminals.

Referring to FIG. 7, a first TRP (i.e. TRP 1) may configure TRP subbands (i.e. SB1 to SB7) by itself or another TRP in the operating frequency band. The first TRP may form a TRP subband group 1 (i.e. TRP SB group 1) using the adjacent TRP subband 1 (i.e. SB1) to TRP subband 4 (i.e. SB4). In addition, the first TRP may form a TRP subband group 2 (i.e. TRP SB group 2) using the adjacent TRP subband 5 (i.e. SB5) to TRP subband 7 (i.e. SB7).

The first TRP may allocate the TRP subband 1 to TRP subband 4 to a first terminal (i.e. UE 1) with which the first TRP communicates. The first TRP may allocate the TRP subband 5 to TRP subband 7 to a second terminal (i.e. UE2) with which the first TRP communicates.

The first TRP may form a terminal subband group 1 (i.e. UE1-UE SB group 1) for the first terminal using the adjacent TRP subband 1 and TRP subband 2. In addition, the first TRP may form a terminal subband group 2 (i.e. UE1-UE SB group 2) for the first terminal using the adjacent TRP subband 3 and TRP subband 4.

The first TRP may form a terminal subband group 1 (i.e. UE2-UE SB group 1) for the second terminal using th adjacent TRP subband 5 and TRP subband 6. In addition, the first TRP may form a terminal subband group 2 (i.e. UE2-UE SB group 2) of the second terminal using the TRP subband 7.

(B) A TRP may perform subband grouping with one or more other TRPs. Such subband grouping may be inter-TRP subband grouping. Inter-TRP subband grouping may be performed in units of TRP/UE subbands or TRP/UE subband groups. One or more TRPs that perform inter-TRP subband grouping may select one or more inter-TRP subband groups from among a configured set of inter-TRP subband groups, and communicate with one or more terminals using the selected one or more inter-TRP subband groups.

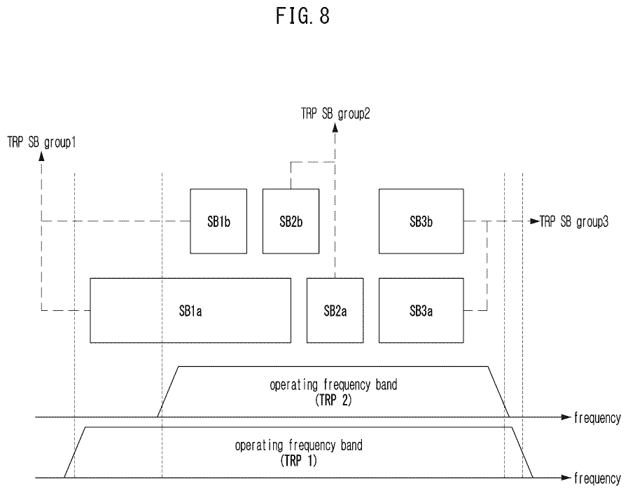

FIG. 8 is a conceptual diagram illustrating a second exemplary embodiment of subband groups of TRPs.

Referring to FIG. 8, a first TRP (i.e. TRP 1) may configure TRP subbands (i.e. SB1a to SB3a) by itself or another TRP in the operating frequency band. A second TRP (i.e. TRP 2) may configure TRP subbands (i.e. SB1b to SB3b) by itself or another TRP in the operating frequency band.

The first TRP or second TRP may form an inter-TRP subband group 1 (i.e. SB group 1) by using the TRP subband 1a (i.e. SB1a) and the TRP subband 1b (i.e. SB1b). The first TRP or second TRP may form an inter-TRP subband group 2 (i.e. SB group 2) using the TRP subband 2a (i.e. SB2a) and the TRP subband 2b (i.e. SB2b). The first TRP or second TRP may form an inter-TRP subband group 3 (i.e. SB group 3) using the TRP subband 3a (i.e. SB3a) and the TRP subband 3b (i.e. SB3b).

As described above, the first TRP and the second TRP may each configure three subbands, and may perform inter-TRP subband grouping in units of a TRP subband. The subband 1a of the first TRP and the subband 1a of the second TRP may form the inter-TRP subband group 1, the subband 2 of the first TRP and the subband 2 of the first TRP may form the inter-TRP subband group 2, and the subband 3 of the first TRP and the subband 3 of the first TRP may form the inter-TRP subband group 3. In addition, the first TRP and the second TRP may select the inter-TRP subband group 3 among the three inter-TRP subband groups and transmit data to the first terminal using the selected inter-TRP subband group 3.

### III. Modulation and Demodulation Operations of TRP

A TRP may perform OFDM modulation/demodulation operations for each configured OFDM operation unit.

(A) OFDM modulation/demodulation operation may include an inverse fast Fourier transform (IFFT) operation and a fast Fourier transform (FFT) operation. The OFDM operation unit may be a subband, subband group, resource set, or the like.

(B) A TRP may perform OFDM modulation/demodulation operations for each OFDM operation unit and obtain a final output signal by combining signals obtained through the OFDM modulation/demodulation operations. For example, the TRP may perform OFDM modulation operation for each subband and obtain a final output signal by combining time-domain OFDM signals obtained through the OFDM modulation operation.

(C) When one or more OFDM operation units have the same TX timing boundary and/or RX timing boundary, the TRP may perform OFDM operation by grouping the one or more OFDM operation units into one. For example, the TRP may perform OFDM modulation for each of the subbands 1 and 2 with different TX timing boundaries, but may perform OFDM modulation for the entire subbands 3 and 4 with the same TX timing boundary.

### IV. Sharing of Subband Configuration Information

A TRP may share subband configuration information with a communicating terminal and/or other adjacent or non-adjacent TRP points. Here, the subband configuration information may be referred to as subband allocation information.

(A) The TRP may share subband configuration information with a terminal or other TRP point(s) through a wired or wireless link. The TRP may transmit subband configuration information to a terminal or other TRP(s) via another network node (e.g. TRP and/or terminal) based on a wired or wireless relay scheme. When transmitting subband configuration information through a wireless link, the TRP may use several transmission schemes below, but may not be limited thereto.

(A1) A transmission scheme using a data channel such as a physical DL/UL/SL shared channel (e.g. physical downlink shared channel (PDSCH), physical uplink shared channel (PUSCH), physical sidelink shared channel (PSSCH), etc.)

(A2) A transmission scheme using control information such as DL/UL/SL control information (e.g. downlink control information (DCI), uplink control information (UCI), sidelink control information (SCI), etc.) on a physical DL/UL/SL control channel (e.g. physical downlink control channel (PDCCH), physical uplink shared channel (PUCCH), physical sidelink control channel (PSSCH), etc.)

(A3) A transmission scheme radio resource control (RRC) signaling

(A4) A transmission scheme using through a medium access control (MAC) control element (CE)

(A5) A transmission scheme using a Wi-Fi link

(B) The subband configuration information may include at least one of the following configuration information

(B1) Subband configuration information of the TRP

(B2) Subband allocation information of one or more terminals communicating with the TRP (In this case, the TRP may share subband allocation information of all terminals, but may also share only some of them)

(B3) Subband grouping information (intra-TRP subband grouping information, inter-TRP subband grouping information, terminal subband grouping information)

(C) If the TRP includes inter-TRP subband grouping information in the subband allocation information, the TRP may additionally share subband allocation information of the counterpart TRP. Alternatively, if the TRP includes inter-TRP subband grouping information in the subband allocation information, the TRP may not additionally share subband allocation information of the counterpart TRP. If the TRP additionally shares subband allocation information of the counterpart TRP with which the TRP performs inter-TRP subband grouping with another TRP, a method of configuring the subband allocation information of the counterpart TRP may be performed in the same manner as in the above method (B).

### V. Activation or Deactivation of Subbands

A subband of a TRP may be activated or deactivated by the TRP or another TRP.

(A) A method of activating/deactivating a subband may include, but is not limited to, several exemplary embodiments below.

(A1) All subbands or all subband group of a TRP may be activated or deactivated by the TRP or another TRP.

(A2) Some subbands or some subband groups of a TRP may be activated or deactivated by the TRP or another TRP.

(B) Activation/deactivation of a subband may be performed aperiodically within a time window W_{SB_activate}, and may also be performed periodically according to a configured periodicity T_{SB_activate}.

Method 1 of configuring the time window W_{SB_activate} may be a method of specifying the time window with a time offset indicating a start time of the window and a length of the window. Method 2 of configuring the time window W_{SB_activate} may be a method of specifying the time window using a bitmap. Another method of configuring the time window may be a form combining Methods 1 and 2.

For example, one frame may consist of 10 subframes, and the TRP may deactivate a subband during the first to tenth subframe of the tenth frame. To do this, the TRP may use Method 1 to set a time offset of a time window to the first subframe of the tenth frame and set a length of the time window to 5 subframes. The TRP may apply Method 2 to configure bitmaps for frames and subframes, respectively. In other words, the TRP may set a bit corresponding to the tenth frame to 1 and the remaining bits to 0 in the frame bitmap, and set bits corresponding to the first to fifth subframes to 1 in the subframe bitmap.

Here, a time unit of activation/deactivation may be configured as a symbol, slot, mini-slot, sub-frame, or frame, and may also be configured as a group of these (e.g. three consecutive slots may be configured as one time unit).

(C) A transmitting end may inform a receiving end of information on times for activation/deactivation of the subband(s) obtained through a method including Method 1 and/or Method 2, and as a transmission scheme therefor, at least one of transmission schemes below may be used, without being limited thereto.

(C1) A transmission scheme using a data channel such as PDSCH, PUSCH, PSSCH, etc.

(C2) A transmission scheme using control information (e.g. DCI/UCI/SCI) on a control channel such as PDCCH/PUCCH/PSCCH

(C3) A transmission scheme using RRC signaling

(C4) A transmission scheme using a MAC CE

(C5) A transmission scheme using a Wi-Fi link

### VI. Method of Grouping TRPs

One or more TRPs may form a TRP group.

(A) Grouping of TRPs may be performed for each TRP, each TRP subband, each TRP subband group, or each TRP subband resource set.

(B) TRPs in a TRP group may be connected via wired or wireless backhaul, and may exchange data and signaling information for multi-TRP communication. The wired backhaul of the TRPs may include X2 or Xn interfaces. The wireless backhaul of the TRPs may be implemented in a wired/wireless relay scheme using other network node(s) (e.g. TRP and terminal). The message exchange scheme via the wireless backhaul may include, but is not limited to, at least one of schemes below.
(B1) A transmission scheme using a data channel such as PDSCH, PUSCH, PSSCH, etc.
(B2) A transmission scheme using control information (e.g. DCI/UCI/SCI) on a control channel such as PDCCH/PUCCH/PSCCH
(B3) A transmission scheme using RRC signaling
(B4) A transmission scheme using a MAC CE
(B5) A transmission scheme using a Wi-Fi link

(C) A TRP may be included in one or more TRP groups.

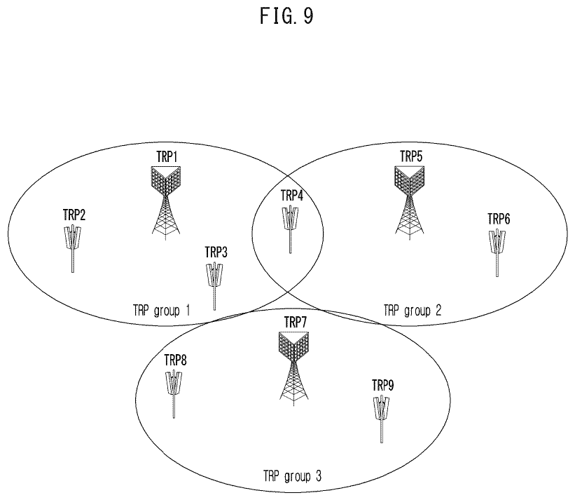

FIG. 9 is a conceptual diagram illustrating a first exemplary embodiment of a method for grouping TRPs.

Referring to FIG. 9, a TRP group 1 may include a first TRP (i.e. TRP 1), a second TRP (i.e. TRP 2), a third TRP (i.e. TRP 3), and a fourth TRP (i.e. TRP 4). A TRP group 2 may include the fourth TRP, a fifth TRP (i.e. TRP 5), and a sixth TRP (i.e. TRP 6). A TRP group 3 may include a seventh TRP (i.e. TRP 7), an eighth TRP (i.e. TRP 8), and a ninth TRP (i.e. TRP 9). The fourth TRP may be included in the TRP group 1 and TRP group 2.

(D) One or more TRPs in a TRP group may act as master TRP(s), and the remaining TRP(s) in the TRP group may act as slave TRP(s). One or more TRPs or all TRPs in a TRP group may communicate with one or more terminals at the same time. Exemplary embodiments of this may include, but are not limited to, the following.

(D1) One or more master TRPs may communicate with one or more terminals at the same time.

(D2) One or more master TRPs and one or more slave TRPs may communicate with one or more terminals at the same time.

(D3) All TRPs in a TRP group may communicate with one or more terminals at the same time.

(E) A master TRP or a slave TRP delegated with the authority to update the group by the master TRP may or may not update TRP(s) belonging to the TRP group at a certain time periodicity. The time periodicity of TRP group update may be set in units of slots, units of subframes, or units of frames, but may not be limited thereto. The time periodicity of TRP group update may be set identically for TRP groups. Alternatively, the time periodicity of TRP group update may be set differently for each TRP group.

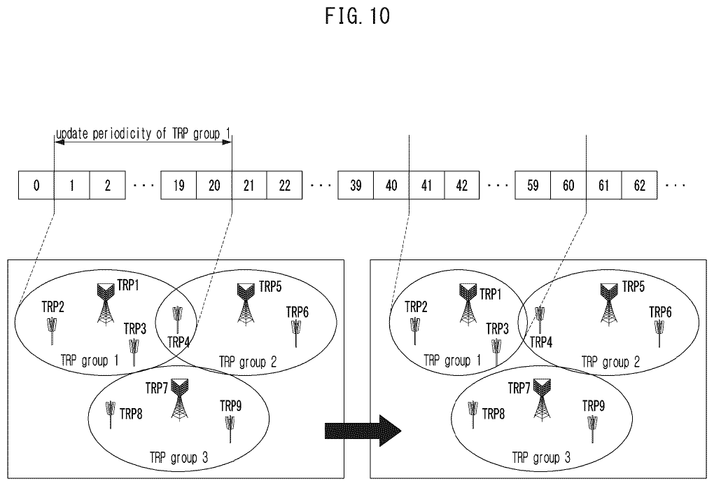

FIG. 10 is a conceptual diagram illustrating a first exemplary embodiment of a method for updating TRP groups.

Referring to FIG. 10, an update periodicity of a TRP group 1 may be 20 subframes. An update start offset may be 1 subframe. The first TRP, which is a master TRP, may check whether to update TRPs belonging to the TRP group 1 every 20 subframes. The first TRP may not update TRP(s) belonging to the TRP group 1 in a second update window (e.g. subframes 21 to 40). The first TRP may update the TRP group 1 by excluding the fourth TRP from the TRP group 1 in the next update window (e.g. subframes 41 to 60).

(F) The TRP group update may be performed for each TRP in the TRP group. For example, a TRP may periodically transmit a group update request signal to a first master TRP of a group to which the TRP currently belongs and a second master TRP of a group to which the TRP wishes to move.

Then, the first master TRP may receive the group update request signal from the TRP. The first master TRP may decide to exclude the corresponding TRP from its TRP group. Accordingly, the first master TRP may transmit a group leave approval signal to the corresponding TRP. The corresponding TRP may receive the group leave approval signal from the first master TRP.

The first master TRP may exclude the corresponding TRP from the TRP group from the earliest TRP update window from a time of transmitting the group leave approval signal. When the TRP receives the group leave approval signal, the TRP may be excluded from the existing TRP group from the earliest TRP update window from a time of receiving the group leave approval signal.

Meanwhile, the second master TRP may receive the group update request signal from the TRP. The second master TRP may decide to include the corresponding TRP in its TRP group. Accordingly, the second master TRP may transmit a group join approval signal to the corresponding TRP. The TRP may receive the group join approval signal from the second master TRP.

The second master TRP may include the corresponding TRP in its TRP group from the earliest TRP update window from a time of transmitting the group join approval signal. When the TRP receives the group join approval signal, the TRP may be included in the new TRP group from the earliest TRP update window from a time of receiving the group join approval signal. Meanwhile, the TRP may receive the group join approval signal from the second master TRP of the group to which it wishes to move, but the TRP may not receive the group leave approval signal from the first master TRP. In this case, the TRP may belong to two groups.

### VII. Configuration of Timing Boundaries of TRP

A TRP may configure timing boundary(ies) for each TRP, each TRP group, each subband, or each subband group.

(A) A TRP may configure a common TX timing boundary t_{TX_common} that serves as a reference for all signal transmissions and a common RX timing boundary t_{RX_common} that serves as a reference for all signal receptions. The common TX timing boundary and the common RX timing boundary may be the same. Alternatively, the common TX timing boundary and the common RX timing boundary may be different from each other. The TRP may operate by selecting an arbitrary timing boundary if the common TX timing boundary or the common RX timing boundary is not configured.

(B) The common TX timing boundary and the common RX timing boundary of the TRP may have the following characteristics.

(B1) The common TX timing boundary and the common RX timing boundary may be configured for each TRP.

(B2) The common TX timing boundary and the common RX timing boundary may be configured for each TRP group.

(B3) The common TX timing boundary and the common RX timing boundary may be configured for each subband.

(B4) The common TX timing boundary and the common RX timing boundary may be configured for each subband group.

(C) The TRP may configured a reference TX timing offset set Λ_{TX_ref}, such as Equation 1, comprising N_{TX_ref} reference TX timing offsets based on the common TX timing boundary. Here, N_{TX_ref} may be a natural number that is greater than or equal to 1.

$${Λ}_{TX \_ ref} = \{ {Δ}_{TX \_ ref , 1} , {Δ}_{TX \_ ref , 2} , ⋯ , {Δ}_{TX \_ ref , {N}_{TX \_ ref}} \} \qquad [ Equation 1 ]$$

The TRP may configure a reference RX timing offset set Λ_{RX_ref}, such as Equation 2, comprising N_{RX_ref} reference RX timing offsets based on the common RX timing boundary. Here, N_{RX_ref} may a natural number that is equal to or greater than 1.

$${Λ}_{RX \_ ref} = \{ {Δ}_{RX \_ ref , 1} , {Δ}_{RX \_ ref , 2} , ⋯ , {Δ}_{RX \_ ref , {N}_{RX \_ ref}} \} \qquad [ Equation 2 ]$$

The reference TX timing offset set and the reference RX timing offset set may be the same. Alternatively, the reference TX timing offset set and the reference RX timing offset set may be different. When the TRP does not configure the reference TX timing offset set, the reference TX timing offset set may be considered as Equation 3.

$${Λ}_{TX \_ ref} = \{ 0 \} \qquad [ Equation 3 ]$$

When the TRP does not configure the reference RX timing offset set, the reference RX timing offset set may be considered as Equation 4.

$${Λ}_{RX \_ ref} = \{ 0 \} \qquad [ Equation 4 ]$$

(D) The TRP may form a reference TX timing boundary set by adding the reference TX timing offsets to the common TX timing boundary. In addition, the TRP may form a reference RX timing boundary set by adding the reference RX timing offsets to the common RX timing boundary. The reference TX timing boundary set and the reference RX timing boundary set may include the following characteristics.

(D1) The reference TX timing boundary set and the reference RX timing boundary set may be configured for each TRP.

(D2) The reference TX timing boundary set and the reference RX timing boundary set may be configured for each TRP group.

(D3) The reference TX timing boundary set and the reference RX timing boundary set may be configured for each subband.

(D4) The reference TX timing boundary set and the reference RX timing boundary set may be configured for each subband group.

(E) The TRP may configure a reference TX timing boundary t_{TX_ref} and a reference RX timing boundary t_{RX_ref}, which are references for data transmission and data reception, respectively, at a specific operation time point, by itself or another TRP, for each TRP, TRP group, subband, or subband group, as in Equation 5 and Equation 6. In Equation 5, Δ*_{TX_ref} may be one of reference TX timing offsets belonging to the reference TX timing offset set (i.e. Δ*_{TX_ref} Λ_{TX_ref}). In Equation 6, Δ*_{RX_ref} may be one of reference RX timing offsets belonging to the reference RX timing offset set (i.e. Δ*_{RX_ref}∈Λ_{RX_ref}).

$${t}_{TX \_ ref} = {t}_{TX \_ common} + {Δ}_{TX \_ ref}^{*} \qquad [ Equation 5 ]$$

$${t}_{RX \_ ref} = {t}_{RX \_ common} + {Δ}_{RX \_ ref}^{*} \qquad [ Equation 6 ]$$

### VIII. Data Transmission and Reception Method of TRP

A TRP may set the same TX timing t_{TX} and/or RX timing t_{RX} as a counterpart TRP by itself or another TRP. Alternatively, the TRP may set a TX timing t_{TX} and/or RX timing t_{RX} different from a counterpart TRP by itself or another TRP. The TRP may transmit data based on the set TX timing. In addition, the TRP may receive data based on the set RX timing. Here, the TX timing may be a timing which is a reference for data transmission at a certain time, and the RX timing may be a timing which is a reference for data reception at a certain time.

(A) The TRP, the counterpart TRP, and the another TRP may be included in the same TRP group. Alternatively, the TRP, the counterpart TRP, and the another TRP may not be included in the same TRP group. The another TRP may set the TX timing and/or RX timing and may be the counterpart TRP. Alternatively, the another TRP may set the TX timing and/or RX timing and may be different from the counterpart TRP.

(B) The TRP may configure a TX timing offset set Λ_{TX}, such as Equation 7, comprising N_{TX_offset} TX timing offsets based on the reference TX timing boundary. Here, N_{TX_offset} may be a natural number that is equal to or greater than 1.

$${Λ}_{TX} = \{ {Δ}_{TX , 1} , {Δ}_{TX , 2} , ⋯ , {Δ}_{TX , {N}_{TX \_ offset}} \} \qquad [ Equation 7 ]$$

The TRP may configure an RX timing offset set Λ_{RX}, such as Equation 8, comprising N_{RX_offset} RX timing offsets based on the reference RX timing boundary. Here, N_{RX_offset} may be a natural number that is equal to or greater than 1.

$${Λ}_{RX} = \{ {Δ}_{RX , 1} , {Δ}_{RX , 2} , ⋯ , {Δ}_{RX , {N}_{RX \_ offset}} \} \qquad [ Equation 8 ]$$

The TX timing offset set and the RX timing offset set may be the same. Alternatively, the TX timing offset set and the RX timing offset set may be different. When the TX timing offset set is not configured, the TRP may consider the TX timing offset set as Equation 9.

$${Λ}_{TX} = \{ 0 \} \qquad [ Equation 9 ]$$

When the RX timing offset set is not configured, the TRP may consider the RX timing offset set as Equation 10.

$${Λ}_{RX} = \{ 0 \} \qquad [ Equation 10 ]$$

(C) The TRP may form a TX timing boundary set by adding the TX timing offsets to the reference TX timing boundary. In addition, the TRP may form an RX timing boundary set by adding the RX timing offsets to the reference RX timing boundary. The TX timing boundary set and the RX timing boundary set may have the following characteristics.

(C1) The TX timing boundary set and the RX timing boundary set may be configured for each TRP.

(C2) The TX timing boundary set and the RX timing boundary set may be configured for each TRP group.

(C3) The TX timing boundary set and the RX timing boundary set may be configured for each subband.

(C4) The TX timing boundary set and the RX timing boundary set may be configured for each subband group.

(D) The TRP may set a TX timing boundary t_{TX} and an RX timing boundary t_{RX}, which are references for data transmission and data reception, respectively, at a specific operation time point, by itself or another TRP, for each TRP, TRP group, subband, or subband group, as in Equation 11 and Equation 12. In Equation 11, Δ*_{TX} may be one of TX timing offsets belonging to the TX timing offset set (i.e. Δ*_{TX}∈Λ_{TX}). In Equation 12, A*_{RX} may be one of RX timing offsets belonging to the RX timing offset set (i.e. Δ*_{RX}∈Λ_{RX}).

$${t}_{TX} = {t}_{TX \_ ref} + {Δ}_{TX}^{*} \qquad [ Equation 11 ]$$

$${t}_{RX} = {t}_{RX \_ ref} + {Δ}_{RX}^{*} \qquad [ Equation 12 ]$$

(E) The first TRP and the second TRP included in one TRP group may perform multiple TRP communication with one terminal at the same time.

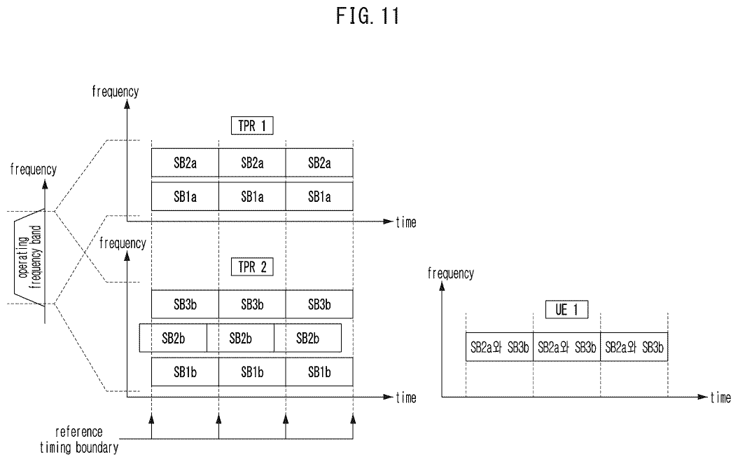

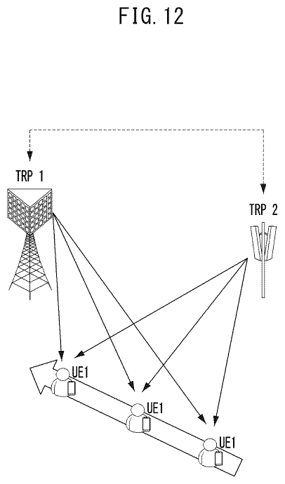

FIG. 11 is a conceptual diagram illustrating a first exemplary embodiment of a method of setting TX timing and RX timing.

Referring to FIG. 11, a first TRP (i.e. TRP1) may configure two subbands (i.e. SB1a, SB2b). A second TRP (i.e. TRP2) may configure three subbands (i.e. SB1a, SB2b, SB2c). The first TRP and the second TRP may form an inter-TRP subband group 1 with the subband 2 (i.e. SB2a) of the first TRP and the subband 3 (i.e. SB3b) of the second TRP. The first TRP and the second TRP may perform multi-TRP communication with a first terminal (i.e. UE1) using the inter-TRP subband group 1.

The first TRP, which acts as a master TRP, may adjust DL TX timings and/or UL RX timings of the first TRP and the second TRP for each subband. For example, the first TRP may set the DL TX timing t_{TX,1} and UL RX timing t_{RX,1} of the subband 2 (SB2a) of the first TRP. In addition, the first TRP may set the DL TX timing t_{TX,2} and the UL RX timing t_{RX,2} of the subband 3 (SB 3b) of the second TRP 2.

FIG. 12 is a conceptual diagram illustrating a first exemplary embodiment of a method of adjusting TX timing and RX timing.

Referring to FIG. 12, a first TRP (i.e. TRP 1) and a second TRP (i.e. TRP 2) may be connected via a backhaul. The first TRP, which acts as a master TRP, may adjust DL TX timings and/or UL RX timings of the first TRP and the second TRP. For example, the first TRP may set the DL TX timing t_{TX,1} of the subband 2 (SB2a) of the first TRP and the DL TX timing t_{TX,2} of the subband 3 (SB 3b) of the second TRP to be the same depending on a location of the terminal. Alternatively, the first TRP may set the DL TX timing t_{TX,1} of the subband 2 (SB2a) of the first TRP and the DL TX timing t_{TX,2} of the subband 3 (SB 3b) of the second TRP to be different from each other depending on a location of the terminal. The first TRP may set the UL RX timing t_{RX,1} of the subband 2 (SB2a) of the first TRP and the UL RX timing t_{RX,2} of the subband 3 (SB 3b) of the second TRP to be the same depending on a location of the terminal. Alternatively, the first TRP may set the UL RX timing t_{RX,1} of the subband 2 (SB2a) of the first TRP and the UL RX timing t_{RX,2} of the subband 3 (SB 3b) of the second TRP to be different from each other depending on a location of the terminal

For example, if a first distance between the first TRP and a terminal (i.e. UE1) is larger than a second distance between the second TRP and the terminal, the first TRP may set the DL TX timing of the first TRP to be smaller than the DL TX timing of the second TRP. In other words, if the terminal is farther away from the first TRP than the second TRP, the first TRP may set the DL TX timings of the first TRP and the second TRP as t_{TX,1}<t_{TX,2} (see FIG. 11).

If the first distance between the first TRP and the terminal is equal to the second distance between the second TRP and the terminal, the first TRP may set the DL TX timing of the first TRP to be equal to the DL TX timing of the second TRP. In other words, if the terminal is located at the similar distances from the two TRPs, the first TRP may set the DL TX timings of the first TRP and the second TRP as t_{TX,1} t_{TX,2} (see FIG. 11).

If the first distance between the first TRP and the terminal is smaller than the second distance between the second TRP and the terminal, the first TRP may set the DL TX timing of the first TRP to be greater than the DL TX timing of the second TRP. In other words, if the terminal is closer to the first TRP than the second TRP, the first TRP may set the DL TX timings of the first TRP and the second TRP as t_{TX,1}>t_{TX,2} (see FIG. 11).

The reference TX/RX timing boundary set, reference TX/RX timing boundary, TX/RX timing boundary set, and TX/RX timing boundary may be reconfigured at a periodicity of a predetermined time. Here, the predetermined time may be set in units of a slot, minislot, subframe, frame, etc., or may be set in units of a group of these (e.g. three continuous slots may be configured as one time unit).

For example, according to movement of the terminal, the first TRP may calculate a first delay time d1 between the first TRP and the terminal. The second TRP may calculate a second delay time d2 between the second TRP and the terminal. In addition, the first TRP and the second TRP may share the first delay time and the second delay time. Accordingly, the first TRP and the second TRP may calculate a delay time difference (delta_d=d1−d2). Accordingly, the first TRP and the second TRP may use the delay time difference to control the TX timing of the first TRP and/or the TX timing of the second TRP. As a result, a transmission signal of the first TRP and a transmission signal of the second TRP may reach the terminal at the same time.

For example, there may be three schemes of adjusting the TX timing.
\textcircled{1} The TRP1, which has a large delay time, may advance its TX timing by delta_d.
\textcircled{2} The TRP2, which has a short delay time, may delay its TX timing by delta_d.
\textcircled{3} The TRP1 may adjust the TX timing, and the TRP2 may also adjust the TX timing so that their signals reach the terminal at the same time.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first transmission and reception point (TRP), comprising:
forming a TRP group including the first TRP and a second TRP;
configuring at least one first subband in a first operating band of the first TRP by performing a role of a master TRP;
generating at least one subband group including the at least one first subband;
setting a transmission (TX) timing and reception (RX) timing for at least one constituent subband of the at least one subband group; and
communicating with a terminal based on the set TX timing and RX timing by using the at least one constituent subband in cooperation with the second TRP.

2. The method according to claim 1, wherein the at least one first subband is at least one of an operating bandwidth, a carrier, a bandwidth part (BWP), a sidelink resource pool, or a resource block (RB) set of unlicensed band communication.

3. The method according to claim 1, wherein the configuring of the at least one first subband comprises:
receiving first subband configuration information for the first operating band from the base station by performing the role of the master TRP; and
configuring the at least one first subband in the first operating band according to the first subband configuration information.

4. The method according to claim 1, further comprising: configuring or not configuring guard band(s) on at least one side of the at least one first subband.

5. The method according to claim 1, wherein the generating of the at least one subband group comprises:
selecting the at least one first subband from among first subbands configured in the first operating band of the first TRP; and
generating the at least one subband group using the at least one first subband selected from among the first subbands.

6. The method according to claim 1, wherein the at least one subband group further includes at least one second subband configured by the first TRP or the second TRP in a second operating band of the second TRP, and the generating of the at least one subband group comprises:
selecting the at least one first subband from among first subbands configured in the first operating band of the first TRP;
selecting the at least one second subband from among second subbands configured in the second operating band of the second TRP; and
generating the at least one subband group using the at least one first subband and the at least second subband.

7. The method according to claim 1, wherein the setting of the TX timing and RX comprises:
determining a common TX timing and a common RX timing that serve as references for signal transmission;
determining a reference TX timing and a reference RX timing for each of TRPs, each of TRP groups, each of subbands, or each of subband groups, based on the common TX timing and the common RX timing; and
determining the TX timing and the RX timing of the at least one constituent subband for each of TRPs, each of TRP groups, each of subbands, or each of subband groups, based on the reference TX timing and the RX reception timing.

8. The method according to claim 7, wherein the determining of the reference TX timing and the reference RX timing comprises:
configuring a reference TX timing offset set and a reference RX timing offset set based on the common TX timing and the common RX timing, respectively;
selecting one reference TX timing offset and one reference RX timing offset from the reference TX timing offset set and the reference RX timing offset set, respectively; and
determining the reference TX timing and the reference RX timing for each of TRPs, each of TRP groups, each of subbands, or each of subband groups, by applying the one reference TX timing offset and the one reference RX timing offset to the common TX timing and the common RX timing, respectively.

9. The method according to claim 7, wherein the determining of the TX timing and the RX timing comprises:
configuring a TX timing offset set and an RX timing offset set based on the reference TX timing and the reference RX timing, respectively;
selecting a TX timing offset and an RX timing offset from the TX timing offset set and the RX timing offset set, respectively; and
determining the TX timing and the RX timing of the at least one constituent subband for each of TRPs, each of TRP groups, each of subbands, or each of subband groups, by applying the TX timing offset and the RX timing offset to the reference TX timing and the reference RX timing, respectively.

10. The method according to claim 1, further comprising:
adjusting the TX timing of the at least one constituent subband according to movement of the terminal; and
communicating with the terminal using the at least one subband based on the adjusted TX timing.

11. The method according to claim 10, wherein the adjusting of the TX timing of the at least one constituent subband comprises:
calculating a difference between a first delay time between the first TRP and the terminal and a second delay time between the second TRP and the terminal according to the movement of the terminal; and
adjusting the TX timing of the at least one constituent subband based on the difference.

12. The method according to claim 1, further comprising: exchanging data and signaling information for multi-TRP communication with the second TRP.

13. The method according to claim 1, further comprising:
allocating the at least one subband or the at least one subband group to the terminal; and
transmitting allocation information of the at least one subband or the at least one subband group to the terminal.

14. A method of a terminal, comprising:
receiving subband configuration information from a first transmission and reception point (TRP);
receiving subband activation information from the first TRP; and
receiving data from the first TRP through at least one subband based on the received subband configuration information and the received subband activation information.

15. The method according to claim 14, wherein the subband configuration information is at least one of configuration information of subbands of the first TRP, configuration information of subbands of the terminal, or configuration information of a subband group including subbands of the first TRP.

16. The method according to claim 14, wherein in the receiving of the subband configuration information, the terminal receives the subband configuration information from the first TRP through at least one of a data channel, a control channel, a radio resource control (RRC) signaling, or a medium access control (MAC) control element (CE).

17. A first transmission and reception point (TRP) comprising at least one processor, wherein the at least one processor causes the first TRP to perform:
forming a TRP group including the first TRP and a second TRP;
configuring at least one first subband in a first operating band of the first TRP by performing a role of a master TRP;
generating at least one subband group including the at least one first subband;
setting a transmission (TX) timing and reception (RX) timing for at least one constituent subband of the at least one subband group; and
communicating with a terminal based on the set TX timing and RX timing by using the at least one constituent subband in cooperation with the second TRP.

18. The first TRP according to claim 17, wherein in the generating of the at least one subband group, the at least one processor further causes the first TRP to perform:
selecting the at least one first subband from among first subbands configured in the first operating band of the first TRP; and
generating the at least one subband group using the at least one first subband selected from among the first subbands.

19. The first TRP according to claim 17, wherein the at least one subband group further includes at least one second subband configured by the first TRP or the second TRP in a second operating band of the second TRP, and in the generating of the at least one subband group, the at least one processor further causes the first TRP to perform:
selecting the at least one first subband from among first subbands configured in the first operating band of the first TRP;
selecting the at least one second subband from among second subbands configured in the second operating band of the second TRP; and
generating the at least one subband group using the at least one first subband and the at least second subband.

20. The first TRP according to claim 17, wherein the at least one processor further causes the first TRP to perform:
adjusting the TX timing of the at least one constituent subband according to movement of the terminal; and
communicating with the terminal using the at least one subband based on the adjusted TX timing.
